(19) United States
(12) Patent Application Publication
(10) Pub. No.: US 2012/0056353 A1
(43) Pub. Date: Mar. 8, 2012

(54) INJECTION-MOLDING SYSTEM INCLUDING PRESSURE-EQUALIZATION CIRCUIT

(75) Inventors: Paul R. Blais, South Burlington, VT (US); Sean Arthur Chase, Essex Junction, VT (US); Thomas Anthony St. Gelais, Colchester, VT (US); Angelo Mier, Colchester, VT (US)

(73) Assignee: Husky Injection Molding Systems Ltd., Bolton (CA)

(21) Appl. No.: 13/318,401

(22) PCT Filed: May 12, 2010
(86) PCT No.: PCT/US10/34532

§ 371 Date: Nov. 1, 2011

Related U.S. Application Data
(60) Provisional application No. 61/182,324, filed on May 29, 2009.

(51) Int. Cl. B29C 45/77

(52) U.S. Cl. 264/328.1; 425/149

(57) ABSTRACT

An injection-molding machine (100), including: an air-open circuit (110); an air-closed circuit (112); and a pressure-equalization circuit (118) connecting with the air-open circuit (110) and the air-closed circuit (112), the pressure-equalization circuit (118) being configured to: (i) operate in a by-pass operation mode, in which the air pressure between the air-open circuit (110) and the air-closed circuit (112) becomes equalized, at least in part, by recycling, at least in part, the air pressure between the air-open circuit (110) and the air-closed circuit (112); and (ii) operate in a pass-through operation mode, in which the air pressure in the air-open circuit (110) and the air-closed circuit (112) is independently controlled.

### TECHNICAL FIELD

The invention generally relates to injection-molding systems, and more specifically to an injection-molding system having a pressure-equalization circuit.

### BACKGROUND

Examples of known molding systems are (amongst others): (i) the HyPET(TRADEMARK) Molding System, (ii) the Quadloc(TRADEMARK) Molding System, (iii) the Hylectric(TRADEMARK) Molding System, and (iv) the HyMet(TRADEMARK) Molding System, all manufactured by Husky Injection Molding Systems Limited (Location: Bolton, Ontario, Canada; www.husky.ca).

A mold can produce several copies of the same parts in a single “shot”. The number of “impressions” in the mold of that part is often incorrectly referred to as cavitation. A mold (also called a tool) with one impression will often be called a single impression (that is, cavity) mold. A mold with two or more cavities of the same parts will likely be referred to as multiple impression (cavity) mold. For example, some extremely high production volume molds (like those for bottle caps) can have over 128 cavities. In some cases multiple cavity tooling will mold a series of different parts in the same tool. Some toolmakers call these molds family molds as all the parts.

Polyethylene terephthalate, commonly abbreviated PET, PETE, or the obsolete PETP or PET-P, is a thermoplastic polymer resin of the polyester family and is used in synthetic fibers; beverage, food and other liquid containers; thermoforming applications; and engineering resins often in combination with glass fiber. Depending on its processing and thermal history, polyethylene terephthalate may exist both as an amorphous (transparent) and as a semi-crystalline material. The semi crystalline material might appear transparent (spherulites <500 nm) or opaque and white (spherulites up to a size of some μm) depending on its crystal structure and spherulite size. Its monomer (bis-β-hydroxyterephthalate) can be synthesized by the esterification reaction between terephthalic acid and ethylene glycol with water as a byproduct, or by transesterification reaction between ethylene glycol and dimethyl terephthalate with methanol as a byproduct. Polymerization is through a polycondensation reaction of the monomers (done immediately after esterification/transesterification) with ethylene glycol as the byproduct (the ethylene glycol is directly recycled in production). The majority of the world's PET production is for synthetic fibers (in excess of 60%) with bottle production accounting for around 30% of global demand. In discussing textile applications, PET is generally referred to as simply “polyester” while “PET” is used most often to refer to packaging applications. The polyester industry makes up about 18% of world polymer production and is third after polyethylene (PE) and polypropylene (PP). PET can be semi-rigid to rigid, depending on its thickness, and is very lightweight. It makes a good gas and fair moisture barrier, as well as a good barrier to alcohol (requires additional “Barrier” treatment) and solvents. It is strong and impact-resistant. It is naturally colorless with high transparency. PET bottles are excellent barrier materials and are widely used for soft drinks. For certain specialty bottles, PET sandwiches an additional polyvinyl alcohol to further reduce its oxygen permeability.

### SUMMARY

The inventors believe that persons of skill in the art do not appreciate the problem(s) associated with hot runner systems, and that the inventors believe the following issues may be resolved by way of the aspects or non-limiting embodiments:

The first issue is that pneumatic valve gates (as used in known hot runner systems) currently have an inherent amount of delay between the time an injection molding machine tells solenoid valves to pressurize/depressurize an air circuit, and the time that the valve stems start to move. This time delay is caused by the time taken to depressurize one side of a piston (actuator for the valve stem) and to pressurize the other side of the piston, until there is enough differential pressure across the piston to overcome friction.

The second issue is that as the cost of energy increases, it may be very expensive to create the amount of compressed air needed for operation of a known pneumatically-actuated valve-gated hot runner systems, especially so for high-cavitation systems that use more compressed air. A high-cavitation system is a molding system that fills 50 to 100 mold cavities (or more) for each molding cycle of the molding system, and such systems are used, for example, to manufacture PET performs.

It will be appreciated that the present invention is set forth and characterized in the main claim(s), while the dependent claims describe other non-limiting features.

An aspect of a non-limiting embodiment provides an injection-molding machine 100, including: an air-open circuit 110; an air-closed circuit 112; and a pressure-equalization circuit 118 connecting with the air-open circuit 110 and the air-closed circuit 112, the pressure-equalization circuit 118 being configured to: operate in a by-pass operation mode, in which the air pressure between the air-open circuit 110 and the air-closed circuit 112 becomes equalized, at least in part, by recycling, at least in part, the air pressure between the air-open circuit 110 and the air-closed circuit 112; and operate in a pass-through operation mode, in which the air pressure in the air-open circuit 110 and the air-closed circuit 112 is independently controlled.

Another aspect of a non-limiting embodiment provides a method of operating an injection-molding machine 100, including: operating a pressure-equalization circuit 118 in a by-pass operation mode, and in a pass-through operation mode.

The aspects of the non-limiting embodiments may be used to: (i) reduce the usage of compressed air by about approximately 50%. Another technical effect that the non-limiting embodiments provide is a reduction in the amount of time delay between the time an injection molding machine sends a signal to air solenoids (located on the injection molding machine) to actuate pneumatic valve gates, and the time when valve stems begin their movement. Another technical effect, in accordance with an aspect of the non-limiting embodiments, is the provision for a “plug and play” option for the injection-molding machine so that no changes are made to the programming of an injection-molding machine controller.

These and other aspects and features of non-limiting embodiments will now become apparent to those skilled in the art upon review of the following description of specific non-limiting embodiments of the invention in conjunction with the accompanying drawings.

### DETAILED DESCRIPTION OF THE DRAWINGS

The invention and its embodiments will be more fully appreciated by reference to the following detailed description of illustrative (non-limiting) embodiments when taken in conjunction with the accompanying drawings, in which:

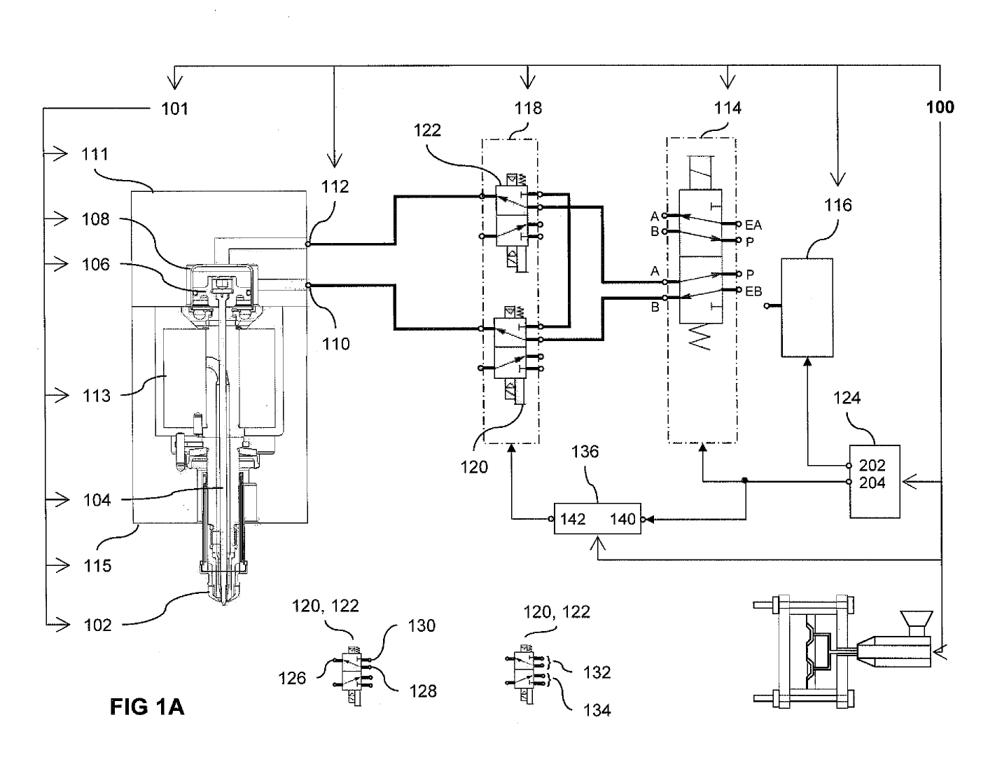

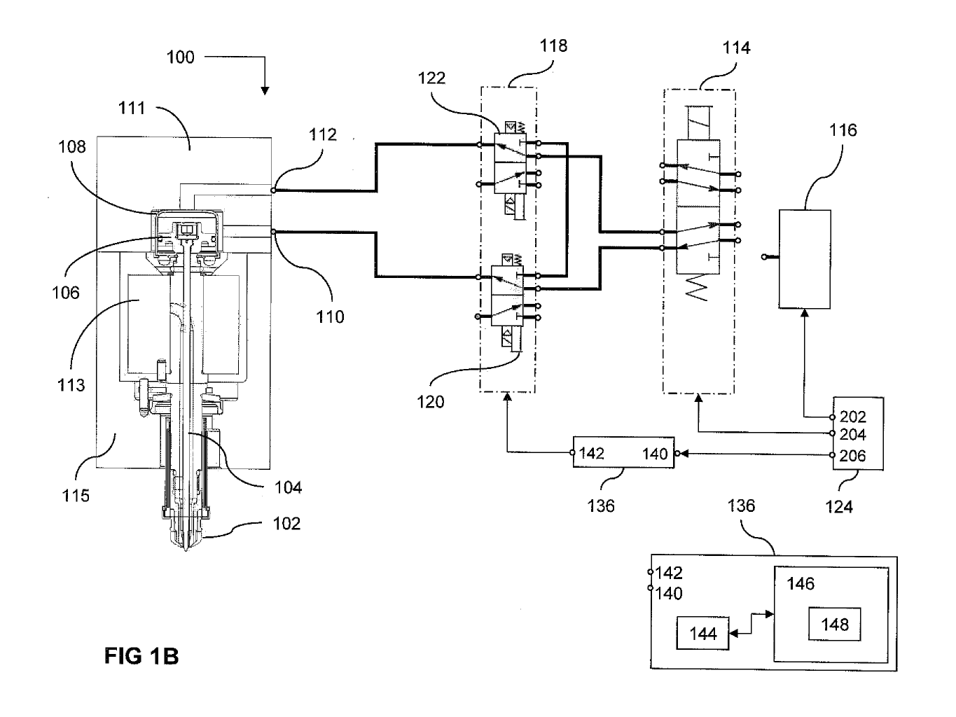

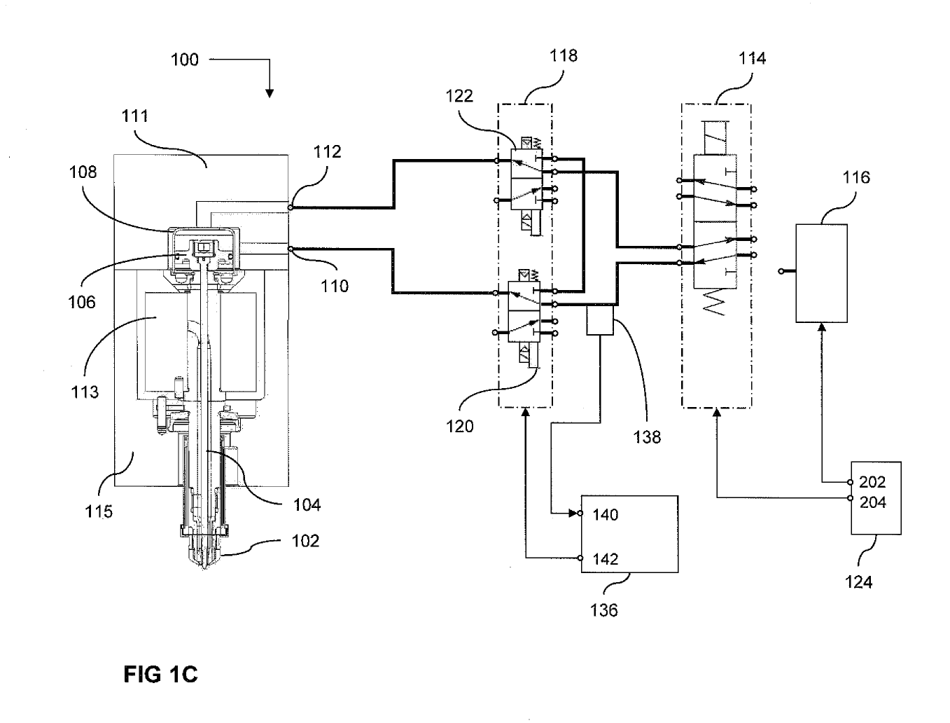

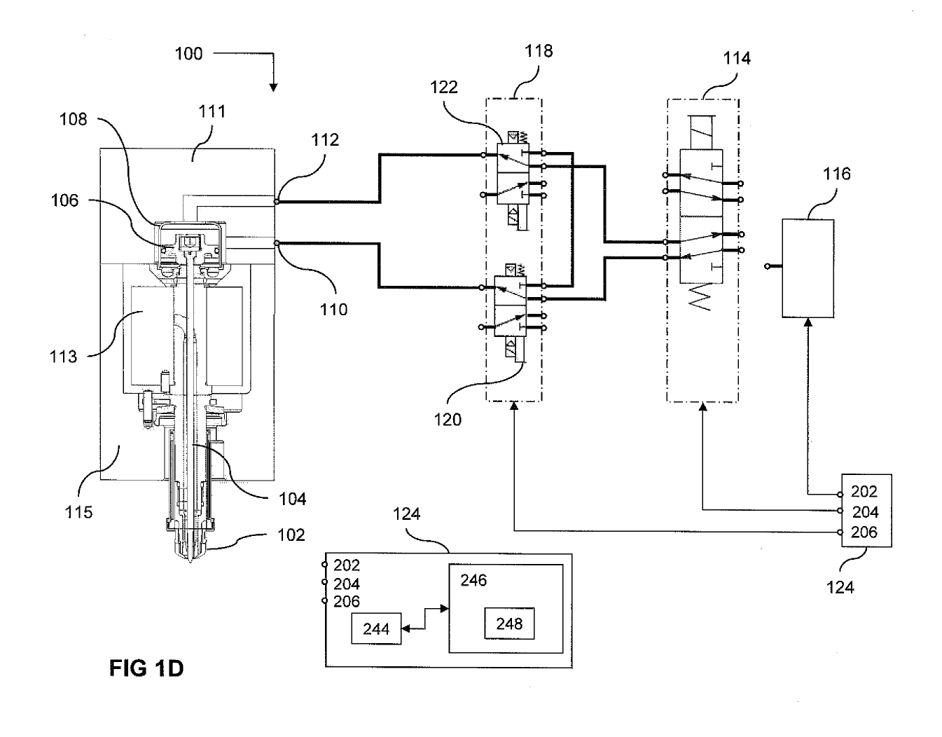

FIGS. 1A, 1B, 1C and 1D depict schematic representations of an injection-molding machine 100 and a hot-runner system 101 in accordance with a first non-limiting embodiment, a second non-limiting embodiment, a third non-limiting embodiment, and a fourth non-limiting embodiment, respectively, and the injection-molding machine 100 includes a pressure-equalization circuit 118 (hereafter referred to as the “circuit 118”) operated in a pressure-static operation mode;

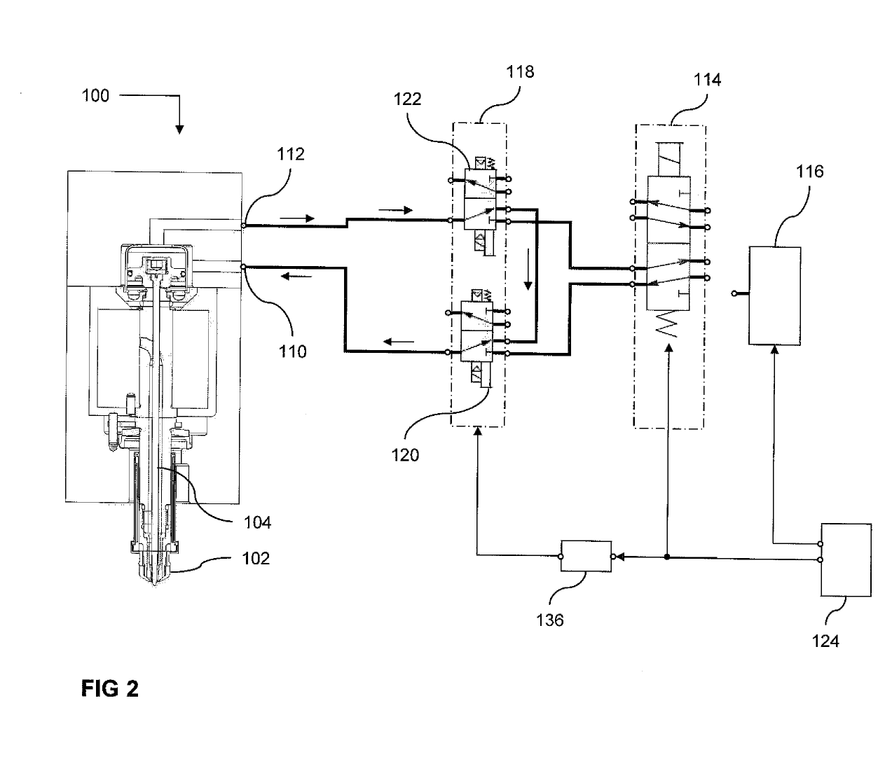

FIG. 2 depicts the circuit 118 of FIG. 1A being operated in a by-pass operation mode;

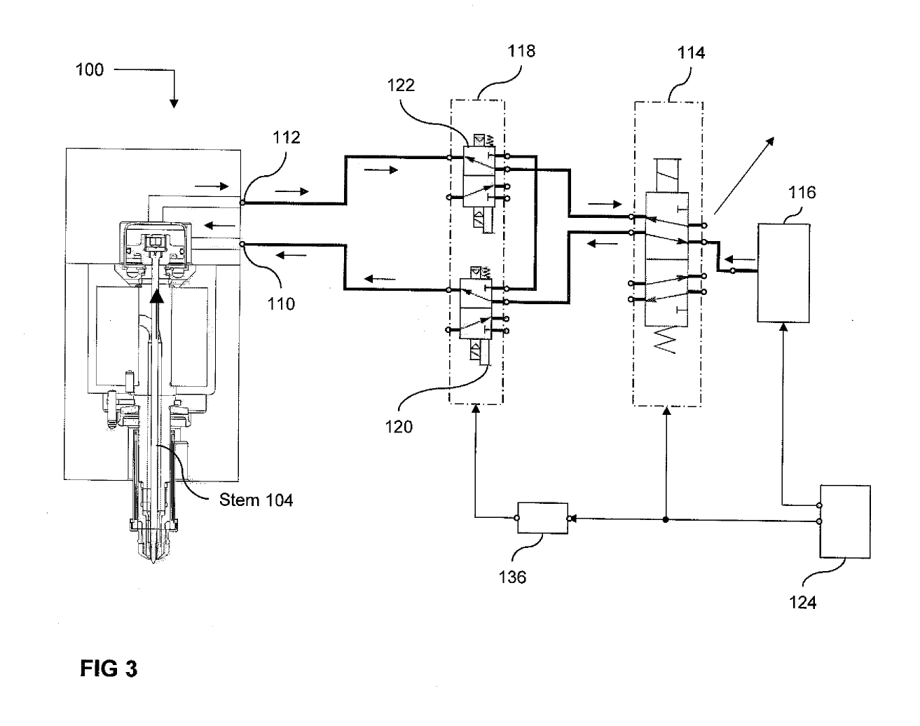

FIG. 3 depicts the circuit 118 of FIG. 1A operated in a pass-through operation mode;

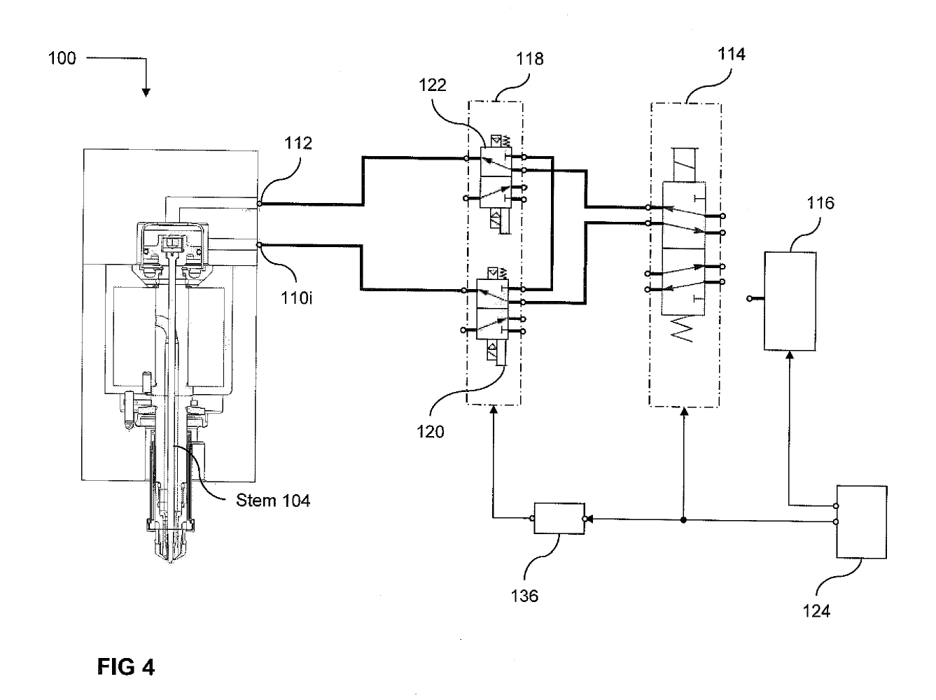

FIG. 4 depicts the circuit 118 of FIG. 1A operated in the static operation mode;

FIG. 5 depicts the circuit 118 of FIG. 1A operated in the by-pass operation mode;

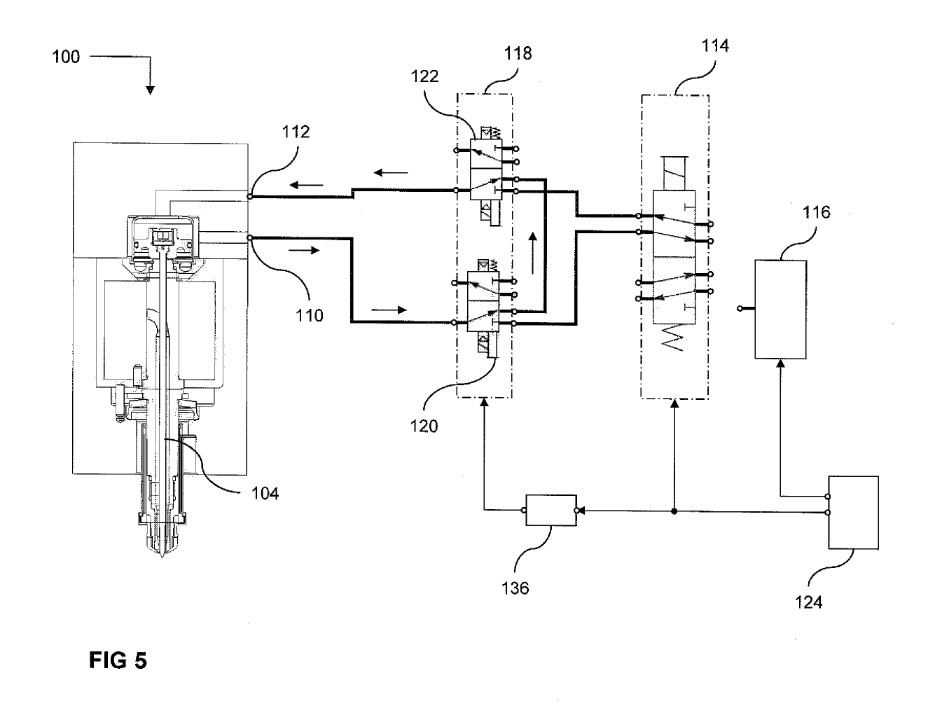

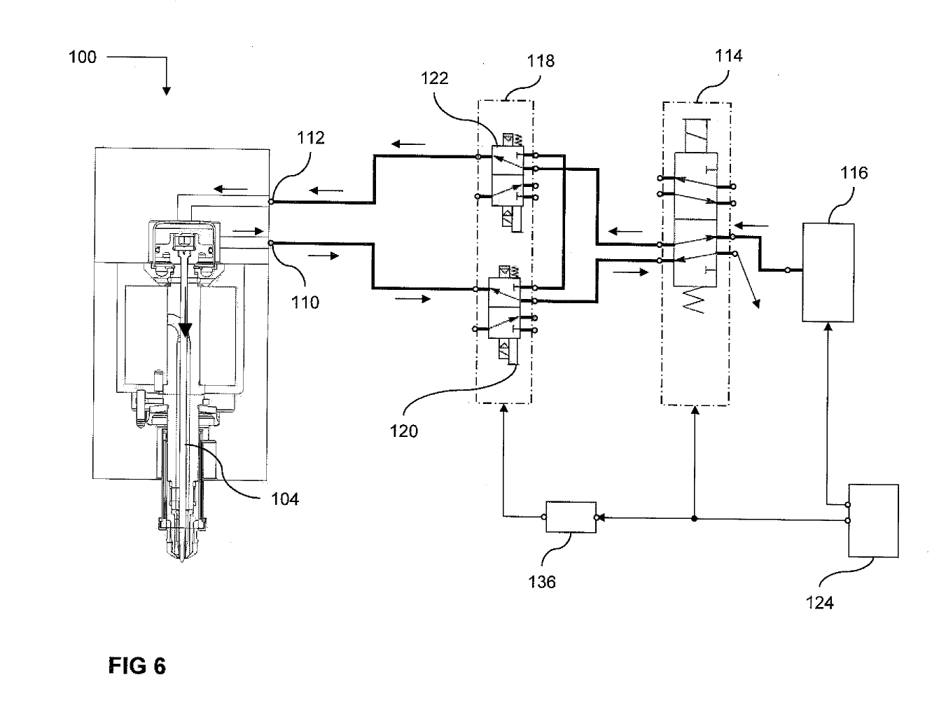

FIG. 6 depicts the circuit 118 of FIG. 1A operated in the pass-through operation mode;

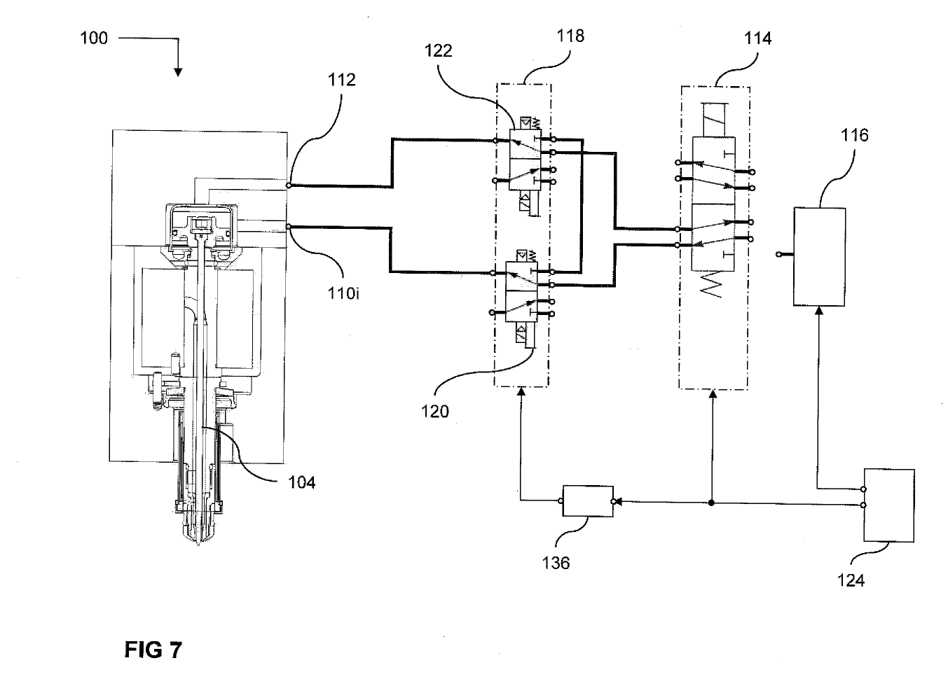

FIG. 7 depicts the circuit 118 of FIG. 1A operated in the static operation mode;

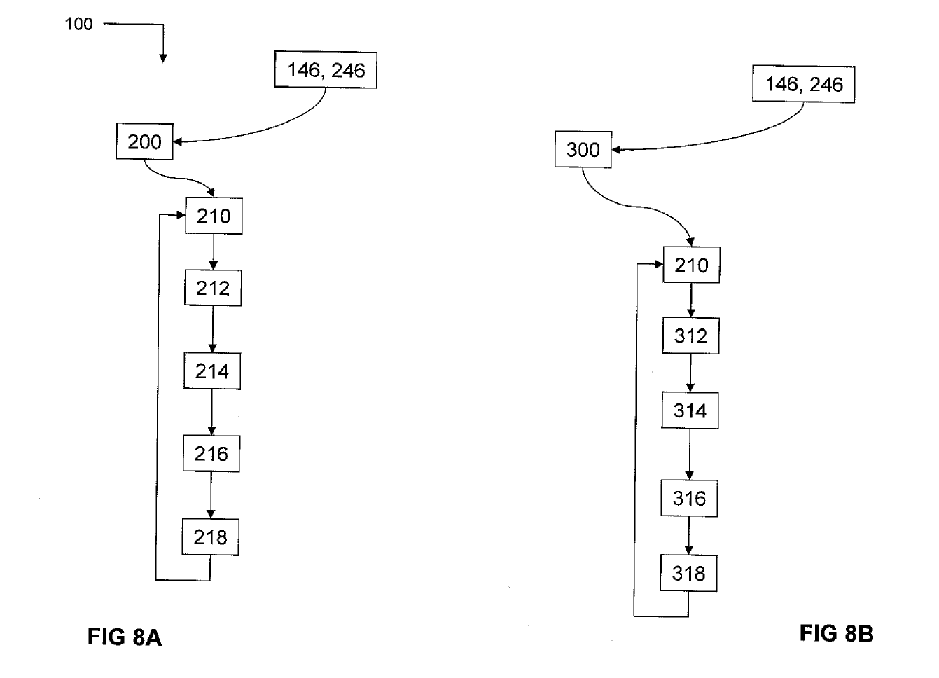

FIG. 8A depicts an operation 200 of an equalization controller 136 used with the circuit 118 of FIG. 1A;

FIG. 8B depicts an operation 300 of the equalization controller 136 used with the circuit 118 of FIG. 1A; and

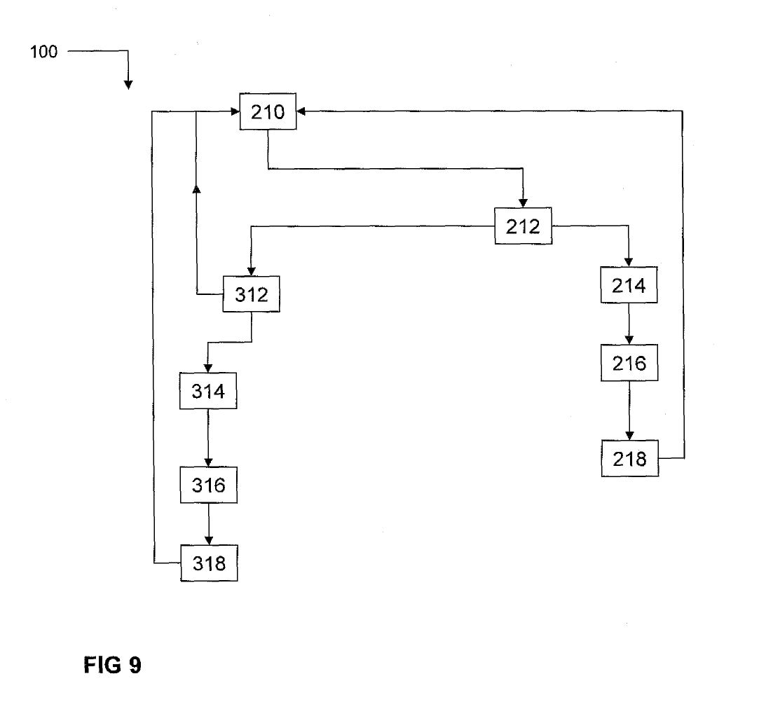

FIG. 9 depicts a combination of the operation 200 and the operation 300 of FIGS. 8A and 8B, respectively.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENT(S)

Reference will now be made in detail to the non-limiting embodiment(s). The injection-molding machine 100 and the hot-runner system 101 may include components that are known to persons skilled in the art, and these known components will not be described here; these known components are described, at least in part, in the following reference books, for example: (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Machines” 3rd Edition authored by JOHANNABER (ISBN 3-446-17733-7) and/or (iv) “Runner and Gating Design Handbook” authored by BEAUMONT (ISBN 1-446-22672-9).

FIGS. 1A, 1B, 1C and 1D depict the schematic representations of the injection-molding machine 100 and the hot-runner system 101 in accordance with a first non-limiting embodiment, a second non-limiting embodiment, a third non-limiting embodiment, and a fourth non-limiting embodiment, respectively. In accordance with FIGS. 1A, 1B, 1C and 1D, the (pressure-equalization) circuit 118 is depicted as being operated in a pressure-static operation mode. It will be appreciated that FIGS. 2 to 7 depict the circuit 118 as being operated in other operation modes, which are described below in association with the description of each respective FIG.

Briefly, the injection-molding machine 100 includes (but is not limited to): (i) a hot-runner system 101, (ii) a valve-stem actuation solenoid 114 (hereafter referred to as the “solenoid 114”, and sometimes referred to as a “valve”), (iii) an air compressor 116 selectively connected with the solenoid 114, (iv) an Injection-Molding Machine controller 124 (hereafter referred to as the “IMM controller 124”), and (v) the circuit 118. In the lower right-hand corner of FIG. 1A, there is depicted a smaller (overall) schematic representation of the injection-molding machine 100.

More specifically, the hot-runner system 101 includes (but is not limited to): (i) a nozzle assembly 102, (ii) a valve stem 104, (iii) a valve-stem piston 106, (hereafter referred to as the “piston 106”) (iv) a piston-pressurization chamber 108, (v) an air-open circuit 110, and (vi) an air-closed circuit 112. Generally speaking, the valve stem 104 is coupled with the air-open circuit 110 and the air-closed circuit 112, and the valve stem 104 is configured to move responsive to a change in air pressure in the air-open circuit 110 and the air-closed circuit 112. Specifically, the valve stem 104 is received in the nozzle assembly 102. The piston 106 is connected with the valve stem 104. The piston-pressurization chamber 108 is configured to receive the piston 106. The piston 106 is movable so as to move the valve stem 104 between the valve-stem closed position the valve-stem open position. The air-open circuit 110 is connected with the piston-pressurization chamber 108. The air-closed circuit 112 is connected with the piston-pressurization chamber 108. The hot-runner system 101 also includes known components such as a backing plate 111, a manifold 113, and a manifold plate 115. The nozzle assembly 102 connects the hot-runner system 101 to a mold assembly (not depicted but known). The valve stem 104 is slidably received in the nozzle assembly 102, and is movable between: (a) a valve-stem closed position in which hot melt is not released from the nozzle assembly 102, and (b) a valve-stem open position, in which the hot melt is released from the nozzle assembly 102 and flows into the mold assembly. The piston-pressurization chamber 108 is configured to slidably and sealably receive the piston 106. The air-open circuit 110 is connected with one side of the piston-pressurization chamber 108. The air-closed circuit 112 is connected with another side of the piston-pressurization chamber 108. The air-open circuit 110 and the air-closed circuit 112 are configured to interact with the piston-pressurization chamber 108.

The IMM controller 124 is configured to control operations of the injection-molding machine 100, the air compressor 116 and the solenoid 114, as described below. The IMM controller 124 includes (but is not limited to): (i) a first output 202 connected to the air compressor 116, and (ii) a second output 204 connected to the solenoid 114. An example of the solenoid 114 is the 4-way air-valve assembly of the type manufactured by NUMATICS INC. (Model Number Mark 25 Valve Part Number 253SA43AK).

FIG. 1A depicts the first non-limiting embodiment, in which the equalization controller 136 (hereafter referred to as the “controller 136”) includes (but is not limited to): (i) an input 140 connected with the output 204 of the IMM controller 124, and an output 142 connected with the circuit 118. The output 142 is used for controlling the pressure-equalization circuit 118. It is envisioned that the circuit 118 may be controlled many ways, and FIGS. 1A, 1B, 1C and 1D provide four examples of how to control the circuit 118. Generally, the circuit 118 is operated in: (i) a by-pass operation mode (which is depicted in FIGS. 2 and 5), and (ii) a pass-through operation mode (which is depicted in FIGS. 3 and 6). In the by-pass operation mode, the air pressure between the circuit 110 and the circuit 112 becomes equalized, at least in part, by recycling, at least in part, the air pressure between the air-open circuit 110 and the circuit 112. In the pass-through operation mode, the air pressure in the circuit 110 and the circuit 112 is independently controlled (that is, the air pressure in the air-open circuit 110 is independently controlled from the air pressure in the air-closed circuit 112.

Several options are contemplated for the circuit 118, such as the circuit 118 includes: (i) a combination of the controller 136 and the controller 124, (ii) the controller 136 without the controller 124, (iii) the controller 124 without the controller 136, and (iv) neither the controller 136 or the controller 124 (that is, the controllers 124, 136 are provided separately from the circuit 118).

According to FIG. 1A, specifically, the output 204 of the IMM controller 124 is connected to both the solenoid 114 and the controller 136. The reason for this arrangement is to provide a first option for the control of the circuit 118 (via the controller 136) for the case where the IMM controller 124 has no available (that is, free) output for dedicated control of the circuit 118 via the controller 136. When the output 204 of the IMM controller 124 is being used to control the solenoid 114, the controller 136 senses the change in the status of the output 204 and in this manner the controller 136 (via the input 140) is aware of the current actuation status of the solenoid 114 and thereby the controller 136 may respond by subsequently controlling the circuit 118 in the manner described below. A technical effect, in accordance with the depiction of FIG. 1A is the provision for a “plug and play” option for the injection-molding machine 100 so that no changes are made to the programming of the IMM controller 124.

In accordance with FIG. 1B, the controller 136 includes (but is not limited to): (i) an input 140, (ii) an output 142, (iii) a processor 144, and (iv) a controller-usable medium 146. The input 140 is configured to connect with an output 204 of the IMM controller 124. The output 204 is connected with the solenoid 114. The output 142 is configured to connect with the circuit 118. The processor 144 is coupled with the input 140 and the output 142. The controller-usable medium 146 is coupled to the processor 144. The controller-usable medium 146 tangibly embodies controller-usable instructions 148 that are configured to direct the processor 144 to control the pressure-equalization circuit 118. It will be described further below that the controller-usable instructions 148 are also configured to direct the processor 144 to: (i) detect a cycle time of the machine 100 based on the input 140, and (ii) control the circuit 118 based on the cycle time that is detected. The instructions are compiled from high-level computer programmed instructions written in a high-level computer programming language (such as C++, etc) as known to those skilled in the art. It is believed that there is sufficient detailed provided in this Detailed Description to enable persons of skill in the art to prepare the instructions for execution by a controller (such as, the controller 136 and/or the controller 124).

FIG. 1A depicts the circuit 118 connecting the air-open circuit 110 and the air-closed circuit 112 with the solenoid 114. The circuit 118 is configured to equalize air pressure within the circuits 110, 112 by recycling, at least in part, air pressure between the circuits 110, 112 in response to moving the valve stem 104. The circuit 118 includes (but is not limited to): (i) an air-open valve 120, (ii) an air-closed valve 122, and (iii) the controller 136. An example of the circuit 118 is provided by the valves 120, 122 and the controller 136, and it will be appreciated that the circuit 118 may be implemented by other structures that provide the same functionality as the valves 120, 122 in combination with the controller 136, and that it would be within the scope of persons skilled in the art to design these other structures. The air-open valve 120 is connected with the air-open circuit 110. The air-closed valve 122 is connected with the air-closed circuit 112. The controller 136 is connected with the valves 120, 122 as well as the IMM controller 124. An example of the air-open valve 120 and the air-closed valve 122 is Valve Model Number 56C-63-611JJ (manufactured by MAC), which are also referred to as “poppet valves”. The controller 136 includes a controller-readable medium (also known as “memory”) tangibly embodying controller-executable instructions for directing the controller 136 to control the valves 120, 122. The instructions were complied from high level computer programmed instructions using a process known to those skilled in the art. An example of the controller 136 is (but is not limited to): (i) Programmable Controller Model Number D0-05DD Micro PLC (manufactured by KOYO ELECTRONICS INDUSTRIES CO., LTD., Tokyo, Japan) in combination with (ii) Operator Interface Model Number EA1-S3MLW (manufactured by C-MORE). Each of the valves 120, 122 include (but are not limited to): (i) an A-side 132, and (ii) a B-side 134. Each of the A-side 132 and the B-side 134 include (a) a cylinder port 126, (b) an input port 128, and (c) an exhaust port 130.

FIG. 1A depicts the circuit 118 being operated in the pressure-static operation mode. The valve stem 104 is statically held in the stem closed position so that the hot melt cannot flow from the nozzle assembly 102 into the mold assembly (not depicted, but known). For the sake of easier description of the non-limiting embodiments depicted in the FIGS, examples are provided for the amounts of air pressure existing in the circuits 110, 112, and it will be appreciated that the non-limiting embodiments are not limited to the specified amounts of the air pressures, and it is understood that these air pressures are described by way of example. The air-closed circuit 112 is pressurized at 100 psi (pounds per square inch). The air-open circuit 110 is pressurized at zero psi (also called “atmospheric pressure”). In the static operation mode, there is no flow of air through the solenoid 114 and the valves 120, 122. The valves 120, 122 (which are normally open) each have an air inlet is coming from the solenoid 114, the outlets are piped to an air-open circuit 110 and a air-closed circuit 112 on of the hot-runner system 101, and the exhausts of the valves 120, 122 are piped to each other. Just before a signal is sent to the solenoid 114, the controller 136 sends a signal to the valves 120, 122 to: (i) close the inlet ports of the valves 120, 122, and (ii) open the outlet ports of the valves 120, 122 to the exhaust ports. When this happens the pressurized air is vented from one side to the other side for a set amount of time, which is enough to make the air pressure equal on both sides of the piston 106, so there is no differential air pressure across the piston 106. Once the exhaust is closed the inlets are opened again, and at the same time the solenoid 114 changes which side of the piston 106 is to be pressurized. Because of the venting that took place, the side of the piston 106 that now is to be pressurized will only have to build up from about half of final operating pressure instead of atmospheric pressure, and the differential pressure needed to move the piston 106 will take less time to build up, and by venting from one side to the other side during equalization (versus venting all of the pressure to atmosphere as is typically done in the prior art), the system uses approximately 50% of the compressed air again, overall using 50% less compressed air per cycle in view of known hot-runner systems.

FIG. 1B depicts the second non-limiting embodiment, in which the IMM controller 124 includes a third output 206 that is connected with the input 140 of the controller 136. The reason for this arrangement is to provide a second option for the control of the circuit 118 for the case where the IMM controller 124 has at least one available output that is free and available for dedicated control of the circuit 118 via the controller 136. In this arrangement, the IMM controller 124 uses separate outputs (204, 206) for controlling the solenoid 114 and the circuit 118 (via the controller 136). In accordance with FIG. 1B, the controller 136 includes (but is not limited to): (i) the input 140, (ii) the output 142, (iii) the processor 144, (and (iv) the controller-usable medium 146. The input 140 is configured to connect with the output (206) of the IMM controller 124. The output 142 is configured to connect with the pressure-equalization circuit 118. The output 142 is used for controlling operation of the pressure-equalization circuit 118. The controller-usable instructions 148 are also configured to direct the processor 144 to: (i) detect a cycle time of the machine 100 based on the input 140, and (ii) control the circuit 118 based on the cycle time that is detected.

FIG. 1C depicts the third non-limiting embodiment, in which the IMM controller 124 is not used to control the circuit 118 via the controller 136. The reason for this arrangement is to provide a third option for the control of the circuit 118 for the case where it is not desirable to change or tamper with the IMM controller 124 in any way whatsoever. In this arrangement, a sensor 138 is connected with the controller 136. The sensor 138 is connected with one of the circuits 110, 112 (that is, between the circuit 118 and the solenoid 114). The input 140 is configured to connect with the sensor 138, and the sensor 138 is connected with an input air line of the pressure-equalization circuit 118; the output 142 is configured to connect with the circuit 118, and the output 142 is used for controlling operation of the pressure-equalization circuit 118. The controller 136 becomes aware of the operation of the solenoid 114 by using the sensor 138 to detect air pressure in the circuits 110, 112. in accordance with FIG. 1C, the controller 136, includes(but is not limited to): (i) the input 140 configured to connect with a sensor 138. The sensor 138 is connected with any one of the air-open circuit 110 and the air-closed circuit 112. The output 142 is configured to connect with the circuit 118. The controller-usable instructions 148 are also configured to direct the processor 144 to: (i) detect a cycle time of the machine 100 based on the input 140, and (ii) control the circuit 118 based on the cycle time that is detected.

FIG. 1D depicts the fourth non-limiting embodiment, in which the controller 136 is not used, and the IMM controller 124 is used to control the circuit 118 via the output 206 of the IMM controller 124. The reason for this arrangement is to provide a fourth option for the control of the circuit 118 for the case where it is not desirable to reduce the cost of the injection-molding machine 100 by removing the controller 136. In accordance with FIG. 1D, the IMM controller 124 includes(but is not limited to): (i) a first output 202, (ii) a second output 204, (iii) a third output 206, (iv) a processor 244, and (v) a controller-usable medium 246. The first output 202 is configured to connect with the air compressor 116. The first output 202 is used for controlling operation of the air compressor 116. The second output 204 is configured to connect with the solenoid 114. The second output 204 is used for controlling operation of the valve-stem actuation solenoid 114. The third output 206 is configured to connect with the pressure-equalization circuit 118. The third output 206 is used for controlling operation of the pressure-equalization circuit 118. The processor 244 is coupled with the first output 202, the second output 204 and the third output 206. The controller-usable medium 246 is coupled to the processor 244. The controller-usable medium 246 tangibly embodies controller-usable instructions 248 configured to direct the processor 244 to control the pressure-equalization circuit 118. The controller-usable instructions 248 are configured to direct the processor 244 to: (i) determine a cycle time of the machine 100, and (ii) control the circuit 118 based on the cycle time.

FIG. 2 depicts the circuit 118 being operated in the by-pass operation mode. Specifically, in the by-pass operation mode (which is depicted in FIGS. 2 and 5), the circuit 118: (i) disconnects, at least in part, the solenoid 114 from the circuit 110 and the circuit 112, and (ii) connects the circuit 110 with the circuit 112, and the air pressure between the 110 and the circuit 112 becomes equalized, at least in part, by recycling, at least in part, the air pressure between the circuit 110 and the circuit 112. In FIG. 2, the valves 120, 122 are placed in the by-pass operation mode, in which the valves 120, 122: (i) disconnect the circuits 110, 112 from the solenoid 114, and (ii) connect the circuit 110 to the circuit 112. More specifically, the instructions embodied in the controller-usable medium direct the controller 136 to control the valves 120, 122 in such as way as to place the valves 120, 122 in the by-pass mode of operation. In the by-pass operation mode, the air pressure in the air-closed circuit 112 is reduced from 100 psi to 50 psi, and the air pressure in the air-open circuit 110 is increased from zero psi to 50 psi. The air compressor 116 is not used during the by-pass operation mode for the purpose of: (i) reducing the air pressure in the air-closed circuit 112, and (ii) increasing the air pressure in the air-open circuit 110. In effect the air pressure in the circuit 112 is being leaked into the circuit 110 during the by-pass operation mode because the air-closed circuit 112 is connected with the air-open circuit 110, and as a result the air pressure in the air-closed circuit 112 drops from 100 psi to 50 psi, while the air pressure in the air-open circuit 110 increases from zero psi to 50 psi. During the by-pass operation mode, the air compressor 116 does not operate. Air pressure from top portion of the piston-pressurization chamber 108 is transferred to the bottom portion of the piston-pressurization chamber 108, and as a result this arrangement equalizes the air pressure on the top and bottom portions of the piston-pressurization chamber 108. Clearly, since the air compressor 116 does not work during this operation, a savings in energy may be realized while the circuits 110, 112 become pressurized. FIG. 3 depicts the circuit 118 being operated in the pass-through operation mode. Specifically, in the pass-through operation mode (which is depicted in FIGS. 3 and 6), the circuit 118: (i) disconnects and isolates the circuit 110 from the circuit 112, and (ii) connects the solenoid 114 with the circuit 110 and the circuit 112, and then the air pressure in the circuit 110 and the circuit 112 is independently controlled so that the air compressor 116 actuates, via the solenoid 114, movement of the valve stem 104. The circuit 118 can also be configured to equalize, at least in part, the air pressure between the circuit 110 and the circuit 112 by recycling, at least in part, the air pressure between the circuit 110 and the circuit 112 without usage of the air compressor 116. In FIG. 3, the piston 106 is moved from the stem closed position to the stem-open open position. Initially the valve stem 104 is in a closed position. The controller 136 operates or controls the valves 120, 122 so that the valves 120, 122 are operated in the pass-through operation mode, in which: the valves 120, 122 of the circuit 118 are operated so as to: (i) connect the circuits 110, 112 with the solenoid 114, and (ii) isolate the circuit 110 from the circuit 112. The IMM controller 124 controls or operates the solenoid 114 and the air compressor 116, so that (i) the solenoid 114 connects with the air compressor 116, and (ii) the air compressor 116 supplies air pressure (such as, 100 psi) to the solenoid 114, and in this arrangement pressurized air passes from the solenoid 114 to the valve 120. The controller 136 controls the circuit 118, so that: (i) the valve 120 passes the air pressure from the solenoid 114 to the circuit 110 so that the air pressure in the circuit 110 increases from 50 psi to 100 psi, and (ii) the valve 122 passes the air pressure to ambient so that the air pressure in the circuit 112 to become reduced from 50 psi to zero psi (that is, ambient pressure).

FIG. 4 depicts the circuit 118 operated in the static operation mode, in which the valve stem 104 is positioned in the fully open position, so that the hot melt may continue to flow from the nozzle assembly 102 into the mold assembly. The circuit 110 is now statically held (or maintained) at 100 psi, and the circuit 112 is maintained at zero psi. It is appreciated that for FIGS. 4 and 5, the valve stem 104 is not literally depicted as being open, but in fact the valve stem 104 is indeed open, and FIGS. 4 and 5 are merely used for the depiction of the modes of operation of the circuit 118. and not necessarily depicts whether the valve stem 104 is open or closed per se.

FIG. 5 depicts the circuit 118 operated in the by-pass operation mode. The valve stem 104 is in the open position. The air compressor 116 is not operated to provide air pressure to the solenoid 114. The controller 136 is instructed to control the valves 120, 122 so that the valve 120, 122: (i) disconnect or isolate the solenoid 114 from the circuits 110, 112, and (ii) connect the circuit 110 to the circuit 112, and as a result of this arrangement the air pressure in the circuit 110 decreases from 100 psi to 50 psi, and the air pressure in the circuit 112 increases from zero psi to 50 psi.

FIG. 6 depicts the circuit 118 operated in the pass-through operation mode. The valve stem 104 is being moved from the open position to the closed position. The air compressor 116 is operated to supply air pressure to the solenoid 114; the valves 120, 122 are controlled by the controller 136 so as to: (i) connect the solenoid 114 with the circuits 110, 112, and (ii) isolate the circuit 110 from the circuit 112, so that the air pressure in the circuit 110 further decreases from 50 psi to zero psi, and the air pressure in the circuit 112 further increases from 50 psi to 100 psi.

FIG. 7 depicts the circuit 118 operated in the static operation mode, in which the air pressure in the circuit 110 is maintained at zero psi, and the air pressure in the circuit 112 is maintained 100 psi. The valve stem 104 is positioned in the fully closed position, such that the hot melt is prevented from flowing from the nozzle assembly 102 to the mold assembly.

FIG. 8A depicts the operation 200 of the controller 136 used with the circuit 118 of FIG. 1. It will be appreciated that the operations depicted in FIGS. 8A, 8B and FIG. 9 may be implemented as instructions to be executed by the IMM controller 124 (as depicted in FIG. 1D) or the controller 136 (as depicted in FIGS. 1A, 1B, 1C). The inventors have discovered that equalizing the air pressure between the air-open circuit 110 and the air-closed circuit 112 before actuating movement of the valve stem 104 will result in: (i) a reduction in valve activation time by up to approximately 60% (in view of known hot-runner systems), (ii) a reduction of air consumption by up to approximately 50% (in view of known hot-runner systems), and a reduction of exhaust noise emanating from the solenoid 114 by up to approximately 10 db (decibels). The inventors believe that there are no known hot-runner systems that operate to equalize the air pressure between the air-open circuit 110 and the air-closed circuit 112.

In known hot-runner systems, it is typical that in order to integrate a controller, additional outputs may be required from the injection-molding machine 100. In known hot-runner systems (not depicted), in order to actuate a valve stem using a solenoid valve, the known controller of the known injection-molding machine sends a digital output to the known solenoid. The digital output can be monitored by the known controller, but the trick is to know when the hot-runner system needs to be air-pressure equalized. For known hot-runner systems using this type of integration, the known controller would need additional outputs to know: (i) when a mold assembly (not depicted but known) is open and closed, and (ii) when the known injection-molding machine is operating in automatic operation mode, and unfortunately this arrangement increases the cost and the complexity of the installation. Therefore, it will be appreciated that the known controllers do not operate in a true “plug&play” fashion.

On the other hand (advantageously), the controller 136 of FIG. 1 (which operates in accordance with the aspects of the non-limiting embodiments) operates as a true “plug&play” controller. The advantage of the circuit 118 is that it does not prevent normal operation of a two-position solenoid installed on most known injection-molding machines. Due to the normally open status of the valves 120, 122, the valve stem 104 will cycle normally as if the circuit 118 was not installed. The controller 136 uses this phenomenon to allow the injection-molding machine to run without any output from the controller 136. When the injection-molding machine is run (or operated) in the manual operation mode, the controller 136 will simply monitor the digital output but not equalize the air pressure (in the circuits 110, 112) because the outputs to the valves 120, 122 are not consistent. As soon as the outputs to the valves 120, 122 are consistent (for example, within three cycles of a prescribed time), the controller 136 realizes the injection-molding machine is operating in a consistent automatic operation mode. The controller 136 has calculated the cycle time based on the outputs to the solenoid 114 (or air pressure increase sensed at the sensor 138). Because cycle times are repeatable to within, for example, 0.02 seconds on the injection-molding machine, the controller 136 can predict the time when the next actuation cycle will occur. The controller 136 will pre-equalize the circuits 110, 112 before the next actuation cycle. This arrangement reduces air usage, reduces noise and provides faster valve-stem actuation. When the signal is received to cycle the valve stem 104, the controller 136 will turn off the circuit 118 allowing the valve stem 104 to cycle. The controller 136 learns the cycle time of the injection-molding machine and controls the circuit 118 with, preferably, a digital output from: (i) the injection-molding machine 100 to the solenoid 114, or alternatively the output of the IMM controller 124, or alternatively (ii) with no outputs if the sensor 138 is used to sense air pressure in any one of the circuits 110, 112. The technical advantage is that by using the controller 136 which can teach itself the amount of time required for the injection-molding cycle, the only inputs required are for: (i) valve-stem open, and/or (ii) valve-stem close, or (iii) none at all. Also, if processing engineers change the cycle on the injection-molding machine, the controller 136 will automatically update itself to the new cycle thereby the process engineers can avoid having to re-program the controller with the new cycle time.

The controller 136 automatically controls equalizing of the circuits 110, 112 in the hot-runner system 101. When the injection-molding machine operates in automatic operation mode, the controller 136 will teach itself the cycle time, and then apply a known time for equalizing of the hot-runner system 101 to ensure the piston 106 has zero differential pressure prior to receiving the signal to actuate the valve stem 104 connected to the piston 106. The controller 136 will continually monitor and teach itself the cycle time (of the injection-molding machine 100) to ensure that any changes to the cycle time will be taken into account when determining to enable/disable the circuit 118. This arrangement limits the requirement for inputs to the valve-stem open, the valve-stem close, and machine in automatic operation mode.

Turning now to FIG. 8A, The operation 200 includes (but is not limited to): (i) an operation 210, (ii) and operation 212, (iii) and operation 214, (iv) an operation 216, and (v) an operation 218. The purpose of operations 212, 214, 216 is to determine: (a) open and close cycle times, and (b) whether the injection molding machine is running in automatic operation mode based on three equal (within user adjustable tolerance) cycle times in a row. The purpose of operation 218 is equalization valve control (with user adjustable equalization time).

Operation 210 includes (but is not limited to) a monitoring operation, including monitoring: (i) the valve stem and the pneumatic valve signal, or (ii) a transducer or the sensor 138 of FIG. 1C (such as, a pneumatic pressure sensor).

Operation 212 includes (but is not limited to) a low/high determining operation, including determining IF a low to a high transition indicates a start time of the open cycle of the valve stem 104, THEN start a stem-open cycle timer and then go to operation 214, ELSE go to operation 210.

Operation 214 includes (but is not limited to) a high/low determining operation, including determining IF a high to low transition indicates the end of the open cycle of the valve stem 104, THEN stop the stem open cycle timer, store the time value into an open time buffer, and then go to operation 216, ELSE go to operation 212.

Operation 216 includes (but is not limited to) a comparison operation, including comparing the last three open times in buffer to each other, and IF all three values are equal (that is, within a tolerance limit) to each other, THEN enable open cycle equalization (that is, change the operation mode of the circuit 118 from by-pass operation mode to pass-through operation mode), and calculate average open cycle time, IF NOT disable open cycle equalization. The reason for calculating the cycle time is to determine whether the cycle time is stable or not stable. If the cycle time is stable, then the circuit 118 is to be used in pass-through operation mode, and if the cycle time is not stable (that is, the machine 100 is some sort of transitory operation and likely needs more time to settle its cycle time into a consistent amount). It is preferred to make sure that the cycle time is stable. During the time that the cycle time is unstable, the algorithm is “learning” about the cycle time while keeping the circuit 118 in the by pass operation mode. Before the valve stem 104 is moved, the circuit 118 preferably operates so as to “pre-equalize” the air pressure; that is: perform air pressure equalization before the valve stem 104 is moved (in this manner, the algorithm anticipates the need to change the air pressure using the pass-through operation mode, and changes the air pressure in the circuits 110, 112 before the valve stem 104 is moved).

Operation 218 includes (but is not limited to) a determination operation, including determining IF open cycle equalization is enabled, THEN energize the valves 120, 122 (so as to equalize the air pressure in the circuits 110, 112) when (“open cycle average time” minus “equalization time”)<=“open cycle timer”<=“open cycle average time” (that is, when the difference between the open cycle average time and equalization time is less than or equal to the open cycle timer, and the open cycle timer is less than or equal to the open cycle average time), and then go to Operation 210.

FIG. 8B depicts the operation 300 of the controller 136 used with the circuit 118 of FIG. 1. The purpose of operations 312, 314, 316 is to determine the open cycle time and the close cycle time and whether the injection-molding machine 100 is running in automatic operation mode based on three equal cycle times (within a user-adjustable tolerance) in a row. The purpose of operation 318 is equalization valve control with user adjustable equalization time.

The operation 210 is executed before the operation 312 is executed. Operation 210 includes (but is not limited to): a monitoring operation, including monitoring: (a) the valve stem 104 and the pneumatic valve signal, or (b) the sensor 138 (for example, a pneumatic pressure sensor).

Operation 312 includes (but is not limited to) determining IF a high to low transition indicates the start of the close cycle of the valve stem 104, THEN start the stem close cycle timer, and then go to Operation 314.

Operation 314 includes (but is not limited to) determining IF a low to high transition indicates the end of the close cycle of the valve stem 104, THEN stop the stem close cycle timer, store the time value into the close time buffer, and then go to operation 316.

Operation 316 includes (but is not limited to) a comparison operation, including comparing the last three close times in the buffer to each other, and IF all three values are equal (that is, within a tolerance limit) to each other THEN enable the circuit 118 during the close cycle (that is, equalize the air pressure in the circuits 110, 112) and calculate average time for the close cycle time, IF NOT THEN disable equalization of the air pressure for the duration of the close cycle, and then go to operation 318.

Operation 318 includes (but is not limited to) determining IF the “close cycle equalization” is enabled, THEN energize the valves 120, 122 when (“close cycle average time” minus “equalization time”)<=“close cycle timer”<=“close cycle average time” (that is, when the difference between the “close cycle average time” and the “equalization time” is less than or equal to the value in the “close cycle timer”, and the “close cycle timer” is less than or equal to the “close cycle average time”), and then go to operation 210.

FIG. 9 depicts a combination of the operation 200 and the operation 300 of FIGS. 8A and 8B, respectively. It will be appreciated that operation 212 may be performed first then operation 312 (as depicted in FIG. 9), or operation 312 may be performed first followed by operation 212 (which is not depicted).

Another aspect of the equalized air design is the capability of detecting a stuck valve stem. In the circuits 110, 112 there are initial system volumes and final volumes. For valve stem opening, the initial volume is with the valve stem 104 in the closed position. The final volume is with the valve stem 104 in the open position. The final volume will always be larger than the initial volume by the volume of air in each valve stem stroke (i.e. area of piston times the stroke length of the piston). When the circuit 118 equalizes the air pressure, it is equalizing between initial open volume with final closed volume or initial closed volume with final open volume. For normal operations, these volumes will not change and the equalized air pressure should be consistent. If for some reason the valve stem 104 should become stuck, this will change both the initial volume and final volume for both the open and closed systems. In turn, this will also affect the equalization pressure. By measuring and comparing the equalization pressure for each cycle, it is possible to detect when the valve stem 104 becomes stuck (that is, does not move). It may not be possible to know which specific valve stem is stuck, however, the algorithm would permit knowing that some unidentified valve stem is stuck. Now, if it is desired to continue to use the injection-molding machine 100 with the stuck stem (which would require turning off the drop for that stuck valve stem), the end user will be able to re-calibrate the system for the new system volumes (that is, initial open, final open, initial closed, final closed). By recalibrating the software (instructions), the end user should be able to detect when the next valve stem becomes stuck.

It is noted that the foregoing has outlined some of the more pertinent non-limiting embodiments. This invention may be used for many applications. Thus, although the description is made for particular arrangements and methods, the intent and concept of the invention is suitable and applicable to other arrangements and applications. It will be clear to those skilled in the art that modifications to the disclosed non-limiting embodiments can be effected without departing from the spirit and scope of the invention. The described non-limiting embodiments ought to be construed to be merely illustrative of some of the more prominent features and applications of the invention. Other beneficial results can be realized by applying the disclosed invention in a different manner or modifying the invention in ways known to those familiar with the art. This includes the mixing and matching of features, elements and/or functions between various non-limiting embodiments is expressly contemplated herein, unless described otherwise, above.

What is claimed is:

1. An injection-molding machine (100), comprising:
an air-open circuit (110);
an air-closed circuit (112); and
a pressure-equalization circuit (118) connecting with the air-open circuit (110) and the air-closed circuit (112), the pressure-equalization circuit (118) being configured to:
operate in a by-pass operation mode, in which air pressure between the air-open circuit (110) and the air-closed circuit (112) becomes equalized, at least in part, by recycling, at least in part, the air pressure between the air-open circuit (110) and the air-closed circuit (112); and
operate in a pass-through operation mode, in which the air pressure in the air-open circuit (110) is independently controlled from the air pressure in the air-closed circuit (112).

2. An injection-molding machine (100), comprising:
an air compressor (116);
a valve-stem actuation solenoid (114) being connected with the air compressor (116);
a hot-runner system (101), including: (i) an air-open circuit (110); (ii) an air-closed circuit (112), and (iii) a valve stem (104) being coupled with the air-open circuit (110) and the air-closed circuit (112), the valve stem (104) being configured to move responsive to a change in air pressure in the air-open circuit (110) and the air-closed circuit (112); and
a pressure-equalization circuit (118) connecting with the air-open circuit (110), the air-closed circuit (112) and the valve-stem actuation solenoid (114), the pressure-equalization circuit (118) being configured to:
operate in a by-pass operation mode, in which the pressure-equalization circuit (118): (i) disconnects, at least in part, the valve-stem actuation solenoid (114) from the air-open circuit (110) and the air-closed circuit (112), and (ii) connects the air-open circuit (110) with the air-closed circuit (112), and the air pressure between the air-open circuit (110) and the air-closed circuit (112) becomes equalized, at least in part, by recycling, at least in part, the air pressure between the air-open circuit (110) and the air-closed circuit (112); and
operate in a pass-through operation mode, in which the pressure-equalization circuit (118): (i) disconnects and isolates the air-open circuit (110) from the air-closed circuit (112), and (ii) connects the valve-stem actuation solenoid (114) with the air-open circuit (110) and the air-closed circuit (112), and the air pressure in the air-open circuit (110) and the air-closed circuit (112) is independently controlled so that the air compressor (116) actuates, via the valve-stem actuation solenoid (114), movement of the valve stem (104).

3. The injection-molding machine (100) of claim 2, wherein:
the pressure-equalization circuit (118) is configured to equalize, at least in part, the air pressure between the air-open circuit (110) and the air-closed circuit (112) by recycling, at least in part, the air pressure between the air-open circuit (110) and the air-closed circuit (112) without usage of the air compressor (116).

4. The injection-molding machine (100) of claim 2, wherein:
the pressure-equalization circuit (118), includes:
an air-open valve (120);
an air-closed valve (122); and
a controller (136, 124) being coupled with the air-open valve (120) and the air-closed valve (122).

5. An equalization controller (136), comprising:
an input (140) being configured to connect with an output (204) of an injection-molding machine controller (124), the output (204) being connected with the valve-stem actuation solenoid (114);
an output (142) being configured to connect with the pressure-equalization circuit (118), the output (142) for controlling the pressure-equalization circuit (118);
a processor (144) being coupled with the input (140) and the output (142); and
a controller-usable medium (146) coupled to the processor (144), and tangibly embodying controller-usable instructions (148) being configured to direct the processor (144) to control the pressure-equalization circuit (118) of the injection-molding machine (100) of claim 2.

6. The equalization controller (136) of claim 5, wherein:
the controller-usable instructions (148) are configured to direct the processor (144) to:
detect a cycle time of the injection-molding machine (100) based on the input (140), and
control the pressure-equalization circuit (118) based on the cycle time being detected.

7. An equalization controller (136), comprising:
an input (140) being configured to connect with an output (206) of an injection-molding machine controller (124);
an output (142) being configured to connect with the pressure-equalization circuit (118), the output (142) for controlling operation of the pressure-equalization circuit (118);
a processor (144) being coupled with the input (140) and the output (142); and
a controller-usable medium (146) coupled to the processor (144), and tangibly embodying controller-usable instructions (148) being configured to direct the processor (144) to control the pressure-equalization circuit (118) of the injection-molding machine (100) of claim 2.

8. The equalization controller (136) of claim 7, wherein:
the controller-usable instructions (148) are configured to direct the processor (144) to:
detect a cycle time of the injection-molding machine (100) based on the input (140), and
control the pressure-equalization circuit (118) based on the cycle time being detected.

9. An equalization controller (136), comprising:
an input (140) being configured to connect with a sensor (138), the sensor (138) being connected with an input air line of the pressure-equalization circuit (118);
an output (142) being configured to connect with the pressure-equalization circuit (118), the output (142) for controlling operation of the pressure-equalization circuit (118);
a processor (144) being coupled with the input (140) and the output (142); and
a controller-usable medium (146) coupled to the processor (144), and tangibly embodying controller-usable instructions (148) being configured to direct the processor (144) to control the pressure-equalization circuit (118) of the injection-molding machine (100) of claim 2.

10. The equalization controller (136) of claim 9, wherein:
the controller-usable instructions (148) are configured to direct the processor (144) to:
detect a cycle time of the injection-molding machine (100) based on the input (140), and
control the pressure-equalization circuit (118) based on the cycle time being detected.

11. An injection-molding machine controller (124), comprising:
a first output (202) being configured to connect with the air compressor (116), the first output (202) for controlling operation of the air compressor (116);
a second output (204) being configured to connect with the valve-stem actuation solenoid (114), the second output (204) for controlling operation of the valve-stem actuation solenoid (114);
a third output (206) being configured to connect with the pressure-equalization circuit (118), the third output (206) for controlling operation of the pressure-equalization circuit (118);
a processor (244) being coupled with the first output (202), the second output (204) and the third output (206); and
a controller-usable medium (246) coupled to the processor (244), and tangibly embodying controller-usable instructions (248) being configured to direct the processor (244) to control the pressure-equalization circuit (118) of the injection-molding machine (100) of claim 2.

12. The injection-molding machine controller (124) of claim 11, wherein:
the controller-usable instructions (248) are configured to direct the processor (244) to:
determine a cycle time of the injection-molding machine (100), and
control the pressure-equalization circuit (118) based on the cycle time.

13. An injection-molding machine (100), comprising:
a hot-runner system (101), including:
a nozzle assembly (102);
a valve stem (104) being received in the nozzle assembly (102);
a valve-stem piston (106) connected with the valve stem (104);
a piston-pressurization chamber (108) configured to receive the valve-stem piston (106);
an air-open circuit (110) being connected with the piston-pressurization chamber (108); and
an air-closed circuit (112) being connected with the piston-pressurization chamber (108);
a valve-stem actuation solenoid (114);
an air compressor (116) being selectively connected with the valve-stem actuation solenoid (114);
an injection-molding machine controller (124), including:
a first output (202) being connected to the air compressor (116); and
a second output (204) being connected to the valve-stem actuation solenoid (114), the injection-molding machine controller (124) being configured to control the air compressor (116) and the valve-stem actuation solenoid (114); and
a pressure-equalization circuit (118) connecting with the air-open circuit (110), the air-closed circuit (112) and the valve-stem actuation solenoid (114), the pressure-equalization circuit (118) being configured to:
operate in a by-pass operation mode, in which the pressure-equalization circuit (118): (i) disconnects, at least in part, the valve-stem actuation solenoid (114) from the air-open circuit (110) and the air-closed circuit (112), and (ii) connects the air-open circuit (110) with the air-closed circuit (112), and air pressure between the air-open circuit (110) and the air-closed circuit (112) becomes equalized, at least in part, by recycling, at least in part, the air pressure between the air-open circuit (110) and the air-closed circuit (112); and
operate in a pass-through operation mode, in which the pressure-equalization circuit (118): (i) disconnects and isolates the air-open circuit (110) from the air-closed circuit (112), and (ii) connects the valve-stem actuation solenoid (114) with the air-open circuit (110) and the air-closed circuit (112), and the air pressure in the air-open circuit (110) and the air-closed circuit (112) is independently controlled so that the air compressor (116) actuates, via the valve-stem actuation solenoid (114), movement of the valve stem (104).

14. A method of operating an injection-molding machine (100), comprising:
operating in a by-pass operation mode, including:
disconnecting, at least in part, a valve-stem actuation solenoid (114) from an air-open circuit (110) and a air-closed circuit (112), the valve-stem actuation solenoid (114) being connected with an air compressor (116), the air-open circuit (110) and the air-closed circuit (112) being coupled with a valve stem (104), the valve stem (104) being configured to move responsive to a change in air pressure in the air-open circuit (110) and the air-closed circuit (112);
connecting the air-open circuit (110) with the air-closed circuit (112), and the air pressure between the air-open circuit (110) and the air-closed circuit (112) becomes equalized, at least in part, by recycling, at least in part, the air pressure between the air-open circuit (110) and the air-closed circuit (112); and
operating in a pass-through operation mode, including:
disconnecting and isolating the air-open circuit (110) from the air-closed circuit (112); and
connecting the valve-stem actuation solenoid (114) with the air-open circuit (110) and the air-closed circuit (112), and the air compressor (116) actuates, via the valve-stem actuation solenoid (114), movement of the valve stem (104).
